(19) United States
(12) Patent Application Publication
(10) Pub. No.: US 2026/0211955 A1
(43) Pub. Date: Jul. 23, 2026

(54) METHOD AND DEVICE FOR PROCESSING PLURALITY OF DOCUMENTS

(71) Applicant: HANWHA SOLUTIONS CORPORATION, Seoul (KR)

(72) Inventors: Sa Rang OH, Seoul (KR); Soo Min Eum, Seoul (KR); Woong Hee Lee, Seoul (KR); Hyun Wook Cho, Seoul (KR)

(73) Assignee: HANWHA SOLUTIONS CORPORATION, Seoul (KR)

(21) Appl. No.: 19/453,299

(22) Filed: Jan. 20, 2026

(30) Foreign Application Priority Data
Jan. 21, 2025 (KR) 10-2025-0008895

(51) Int. Cl. G06F 16/93

(52) U.S. Cl. CPC G06F 16/93

(57) ABSTRACT

Provided are a method and device for processing a plurality of documents. The method of processing a plurality of documents includes: generating a database including documents that are retrieved according to predetermined search criteria; clustering the retrieved documents into a plurality of clusters based on similarity between documents included in the database; and determining priorities of the retrieved documents based on at least one of degrees to which the retrieved documents contain a relevant keyword or degrees to which the retrieved documents contain an irrelevant keyword.

### CROSS-REFERENCE TO RELATED APPLICATION

This application is based on and claims priority under 35 U.S.C. §119 to Korean Patent Application No. 10-2025-0008895, filed on January 21, 2025, in the Korean Intellectual Property Office, the disclosure of which is incorporated by reference herein in its entirety.

### BACKGROUND

### Field

The present disclosure relates to a method and device for processing a plurality of documents.

### Description of the Related Art

Searching for documents containing relevant information among documents such as academic papers, patent documents, or legal documents, and selecting relevant documents from among those retrieved through the search often relies on a user’s empirical expertise. This is because, due to the nature of text, even substantially identical concepts are often expressed in different texts depending on word choice or expression methods, which necessitates an exhaustive review of the relevance of the retrieved documents.

However, because obtaining relevant documents by exhaustively reviewing a vast amount of retrieved documents necessitates excessive human resources, there is a need for a document processing method that enables a user to efficiently review the retrieved documents.

The foregoing background art is technical information that the inventor possessed for deriving the present disclosure or acquired in the course of deriving the present disclosure, and does not necessarily constitute prior art disclosed to the general public prior to the filing of the present disclosure.

### SUMMARY

Provided are a method and device for processing a plurality of documents. In addition, provided is a computer-readable recording medium having recorded thereon a program for causing a computer to execute the method. The objectives of the present disclosure are not limited to those described above, and other objectives may be obtained. Additional aspects will be set forth in part in the description which follows and, in part, will be apparent from the description, or may be learned by practice of the presented embodiments of the disclosure.

According to a first aspect of the present disclosure, there may be provided a method of processing a plurality of documents, the method including: generating a database including documents that are retrieved according to predetermined search criteria; clustering the retrieved documents into a plurality of clusters based on similarity between documents included in the database; and determining priorities of the retrieved documents based on at least one of degrees to which the retrieved documents contain a relevant keyword or degrees to which the retrieved documents contain an irrelevant keyword.

According to a second aspect of the present disclosure, there may be provided a computer-readable recording medium having recorded thereon a program for causing a computer to execute the method according to the first aspect.

According to a third aspect of the present disclosure, there may be provided a device for processing a plurality of documents, the device including: a memory storing at least one program; and a processor configured to operate by executing the at least one program, wherein the processor is further configured to generate a database including documents that are retrieved according to predetermined search criteria, cluster the retrieved documents into a plurality of clusters based on similarity between documents included in the database, and determine priorities of the retrieved documents based on at least one of degrees to which the retrieved documents contain a relevant keyword or degrees to which the retrieved documents contain an irrelevant keyword.

In addition, other methods and systems for implementing the present disclosure, and a computer-readable recording medium having recorded thereon a computer program for executing the methods may be further provided.

Other aspects, features, advantages other than those described above will become apparent from the following drawings, claims, and detailed description of the present disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic configuration diagram of a system for processing a plurality of documents, according to an embodiment;

FIG. 2 is a flowchart for describing a method of processing a plurality of documents, according to an embodiment;

FIG. 3 is a diagram exemplarily illustrating certain identification items extracted from retrieved documents, and content corresponding to the identification items, according to an embodiment;

FIG. 4 is a diagram for describing clustering results and information displayed to a user in relation to the clustering results, according to an embodiment;

FIG. 5 is a diagram for describing information displayed to a user to receive a user input regarding a first threshold or a second threshold, according to an embodiment;

FIG. 6 is a diagram for describing a process of outputting response text for query text received according to a user input, according to an embodiment;

FIG. 7 is a flowchart for describing a method, performed by a user device, of processing a plurality of documents through a first server and a second server, according to an embodiment; and

FIG. 8 is a block diagram of a user device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term "and/or" includes any and all combinations of one or more of the associated listed items. Expressions such as "at least one of," when preceding a list of elements, modify the entire list of elements and do not modify the individual elements of the list.

Advantages and features of the present disclosure and a method for achieving them will be apparent with reference to embodiments of the present disclosure described below together with the accompanying drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used in embodiments are selected as currently widely used general terms as possible, which may vary depending on intentions or precedents of one of ordinary skill in the art, emergence of new technologies, and the like. In addition, in certain cases, there are also terms arbitrarily selected by the applicant, and in this case, the meaning thereof will be defined in detail in the description. Therefore, the terms used herein should be defined based on the meanings of the terms and the details throughout the present description, rather than the simple names of the terms.

Throughout the specification, when a part “includes” a component, it means that the part may additionally include other components rather than excluding other components as long as there is no particular opposing recitation. In addition, as used herein, the terms such as "... unit," or "... module," denote a unit that performs at least one function or operation, which may be implemented as hardware or software or a combination thereof.

In addition, although the terms such as “first” or “second” may be used in the specification so as to describe various elements, these elements should not be limited by these terms. These terms may be only used to distinguish one element from another.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. In addition, the present disclosure may employ known technologies for electronic settings, signal processing, and/or data processing. Terms such as "mechanism", "element", "unit", or "component" may be used in a broad sense and are not limited to mechanical or physical components.

Hereinafter, embodiments will be described in detail with reference to the accompanying drawings. The embodiments may, however, be embodied in many different forms and should not be construed as being limited to the embodiments set forth herein.

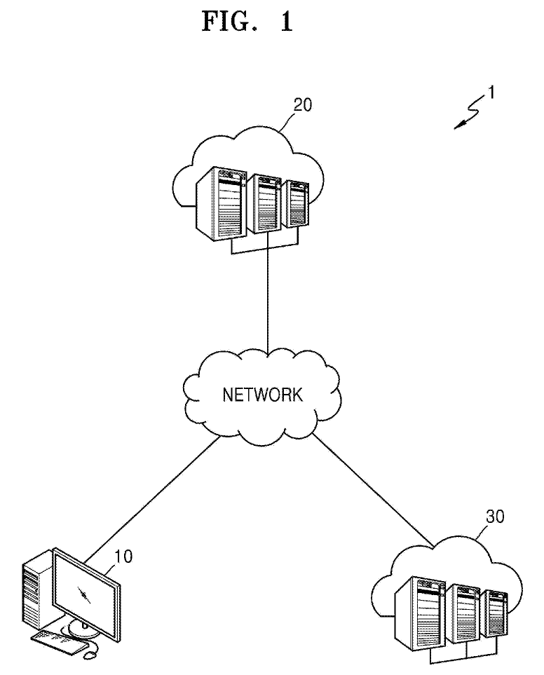

FIG. 1 is a schematic configuration diagram of a system for processing a plurality of documents, according to an embodiment.

Referring to FIG. 1, a document processing system 1 may include a user device 10, a first server 20, and a second server 30.

The user device 10 may be a computing device that is equipped with a display device and a device for receiving a user input (e.g., a keyboard or a mouse), and includes a memory and a processor. In this case, the display device may be implemented as a touch screen to perform a function of receiving a user input. For example, the user device 10 may correspond to a notebook personal computer (PC), a desktop PC, a laptop, a tablet computer, a smart phone, a wearable device, or the like, but is not limited thereto.

The first server 20 may refer to a server that integrally processes execution of collection, storage, reading, and searching of documents. For example, the first server 20 may store documents, and may perform data transmission and reception with the user device 10 or an external device (not shown). For example, the first server 20 may store data related to performing a search, such as a plurality of documents and index information about the plurality of documents, and in response to receiving search criteria, may output documents corresponding to the search criteria.

The second server 30 may refer to a server that generates, based on a large language model, response text for responding to a user’s query text, and integrally processes execution of collection, storage, reading, and searching of data for generating the response text. For example, the second server 30 may store data such as text token information, model training information, context information, or external knowledge information, and in response to query text being input, may generate response text based on the context information or the external knowledge information.

In some embodiments, although not illustrated in FIG. 1, the first server 20 and the second server 30 may each be a computing device including a processor. In this case, the first server 20 and the second server 30 may perform at least some of operations of the user device 10 to be described below with reference to FIGS. 1 to 8.

The user device 10, the first server 20, and the second server 30 may be connected to each other through a network to transmit and receive data to and from each other. Here, the network may refer to a data communication network in a broad sense that enables each component of the system illustrated in FIG. 1 to seamlessly communicate with each other. In an embodiment, the network includes a local area network (LAN), a wide area network (WAN), a value-added network (VAN), a mobile radio communication network, a satellite communication network, and a combination thereof, and may include wired Internet and wireless Internet. Here, examples of wireless communication may include, but are not limited to, a wireless LAN (e.g., Wi-Fi), Bluetooth, Bluetooth Low Energy, Zigbee, Wi-Fi Direct (WFD), ultra-wideband (UWB), Infrared Data Association (IrDA), and near-field communication (NFC).

Hereinafter, an example of a process in which the user device 10, the first server 20, and the second server 30 operate to search for documents and output search results to a user will be described.

The user device 10 may receive a user input including predetermined search criteria for searching for documents. The user device 10 may transmit the search criteria received according to the user input to the first server 20, and the first server 20 may perform a search for documents corresponding to the received search criteria and transmit the documents retrieved through the search to the user device 10. The user device 10 may receive, from the first server 20, the documents corresponding to the search criteria and generate a database including the documents retrieved according to the search criteria.

The user device 10 may extract necessary information from the received documents to generate the database. For example, in a case of receiving patent documents, the user device 10 may extract identification items such as titles of inventions, representative claims, or abstracts, and extract specific content corresponding to each identification item to generate the database.

The user device 10 may cluster the received documents into a plurality of clusters based on similarity between the retrieved documents. Accordingly, each cluster may include documents with similar content. In addition, the user device 10 may output information such as summary information, main keywords, and core features for each of the clusters.

The user device 10 may perform at least one of an operation of excluding at least one of the retrieved documents from the database of the retrieved documents, and an operation of determining priorities for the retrieved documents based on at least one of a relevant keyword or an irrelevant keyword.

Here, at least one of a relevant keyword or an irrelevant keyword may be input by the user, and the at least one input keyword may be a keyword determined by the user based on summary information, main keywords, and core features generated for clusters. Alternatively, at least one of a relevant keyword or an irrelevant keyword may be obtained from the above-described search criteria by the user device 10.

In the present disclosure, a “relevant keyword” refers to a keyword related to specific information that the user aims to retrieve through document search. For example, a “relevant keyword” may refer to a keyword for allowing a document containing the keyword to be determined by the user device as having a high priority. Alternatively, a “relevant keyword” may refer to a keyword for allowing a document containing the keyword to be classified by the user device as a document not to be excluded from a document list displayed to the user.

In addition, in the present disclosure, an “irrelevant keyword” refers to a keyword related to information other than specific information that the user aims to retrieve through document search. For example, in the present disclosure, an “irrelevant keyword” may refer to a keyword for allowing a document containing the keyword to be determined by the user device as having a low priority. Alternatively, an “irrelevant keyword” may refer to a keyword for allowing a document containing the keyword to be classified by the user device as a document to be excluded from a document list displayed to the user.

In the present disclosure, a “relevant keyword” and an “irrelevant keyword” are not limited to a single word. For example, a “relevant keyword” and an “irrelevant keyword” may each refer to a concept including a single word, a plurality of words, or a full sentence composed of a plurality of words and phrases.

The user device 10 may output the retrieved documents to the user on a cluster-by-cluster basis through an interface unit included in the user device 10. In addition, the user device 10 may sort the documents included in each cluster according to the determined priorities, and output the sorted documents to the user.

In addition, in response to receiving query text from the user, the user device 10 may output response text for the query text to the user. Here, the user device 10 may output, to the user, at least one document related to at least one of the query text or the response text. In addition, the user device 10 may output at least one of summary information for each cluster, key keywords for each cluster, or key features for each cluster. In some embodiments, the user device 10 may visualize the information output to the user (e.g., a list of documents included in each cluster, summary for each cluster, keywords for each cluster, features or attribute for each cluster, etc.) and output the visualized information through a display.

In some embodiments, the user device 10 may transmit, to the second server 30, the query text received according to the user input and the retrieved documents. The second server 30 may generate response text for the query text received from the user device 10 by using a large language model. Here, the response text may be generated based on pre-training information of the large language model and information included in the retrieved documents. In this case, the documents uploaded to the second server 30 may include documents included in any one of the plurality of clusters.

The user device 10 may output, to the user, at least one document related to at least one of the query text or the response text, based on similarity between the retrieved documents and at least one of the query text or the response text. In addition, the user device 10 may sort documents in descending order of similarity with at least one of the query text or the response text, and output the sorted documents to the user.

According to the present disclosure, by clustering and systematically classifying retrieved documents based on inter-document similarity, a plurality of documents may be processed to enable a user to review necessary documents more efficiently. For example, the user may preemptively review summary information, main keywords, and core features for each cluster, and then efficiently select a document to be subject to a detailed review. Furthermore, based on a result of the preemptive review of the clusters, the user may effectively select relevant keywords or irrelevant keywords for calculating priorities of the documents or for selecting documents to be excluded from the review.

In addition, according to the present disclosure, the volume of documents to be reviewed by the user may be reduced by establishing priorities for documents based on the relevant keywords and the irrelevant keywords, or by excluding dissimilar documents from the retrieved documents.

Furthermore, according to the present disclosure, more sophisticated response text may be generated by taking the retrieved documents into account during the process of generating the response text for a user query. In particular, according to the present disclosure, providing documents related to query text or response text enables the user to review the documents with greater efficiency.

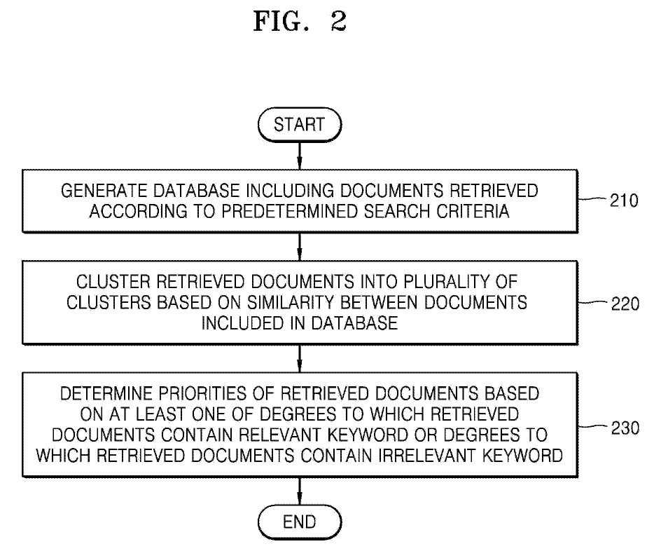

Hereinafter, an example in which the user device operates to process a plurality of documents will be described with reference to FIGS. 2 to 8.

FIG. 2 is a flowchart for describing a method of processing a plurality of documents, according to an embodiment.

Operations to be described below with reference to FIG. 2 may be performed by the user device 10 illustrated in FIG. 1, and in some embodiments, the operations may be performed by a processor included in the user device 10.

In operation 210, the processor may generate a database including documents retrieved according to predetermined search criteria.

In an embodiment, the processor may receive documents corresponding to predetermined search criteria and generate a database including the documents retrieved according to the search criteria. Here, the “search criteria” may include text information such as a keyword for specific information that the user intends to search for, search operator information, and search filter information related to a document search range.

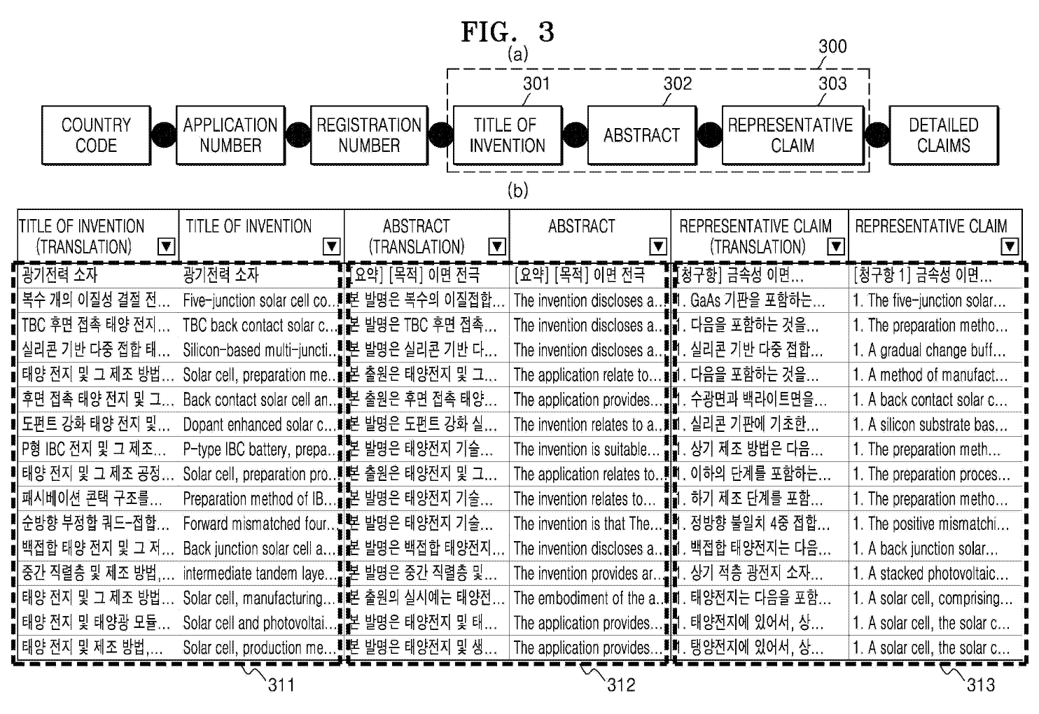

In an embodiment, the processor may extract, from documents corresponding to the search criteria, predetermined identification items and content corresponding to the identification items, to generate a database including the retrieved documents. Here, the “identification item” may refer to a specific format included in a document, such as a table of contents, or specific text or identifier included in the document. In addition, the “content corresponding to the identification item” may refer to body content of a specific table of contents, or text preceding and following specific text or identifier. Specific details regarding a method of generating a database according to an embodiment will be described below with reference to FIG. 3.

In operation 220, the processor may cluster the retrieved documents into a plurality of clusters based on similarity between the documents included in the database. Here, the similarity may include similarity in document content.

In an embodiment, the processor may obtain an embedding vector corresponding to text included in each of the retrieved documents, and calculate similarity between the documents based on similarity scores between the obtained embedding vectors.

That is, in an embodiment, the processor may obtain a single embedding vector for each document by obtaining an embedding vector corresponding to each sentence included in each document, and aggregating a plurality of embedding vectors obtained for the respective documents. In this case, the processor may calculate similarity between different documents based on similarity scores between single embedding vectors respectively obtained for the documents. In addition, the processor may cluster the retrieved documents into a plurality of clusters based on the calculated similarity.

In another embodiment, the processor may obtain an embedding vector corresponding to each sentence included in each document, and calculate similarity between different documents based on similarity score between sets of a plurality of embedding vectors respectively obtained for the documents. In addition, the processor may cluster the retrieved documents into a plurality of clusters based on the calculated similarity.

In another embodiment, the processor may obtain a representative embedding vector representing the content of each document, and calculate similarity between different documents based on similarity scores between the representative embedding vectors respectively obtained for the documents. In addition, the processor may cluster the retrieved documents into a plurality of clusters based on the calculated similarity.

In an embodiment, the processor may cluster the retrieved documents into global clusters based on similarity between all the retrieved documents, and cluster the documents included in each global cluster into local clusters based on similarity between the documents included in the global cluster. Accordingly, the hierarchical structuring of a plurality of clusters enables systematic classification and management of documents, thereby enabling the user to search for required information with higher speed and accuracy.

In an embodiment, the processor may output information such as summary information for each cluster, main keywords for each cluster, or core features for each cluster. In detail, the processor may output information such as summary information for each cluster, by analyzing the content of the documents included in the cluster according to an extractive summarization algorithm or an abstractive summarization algorithm.

In addition, as described above, in a case where the retrieved documents are clustered to be hierarchically structured into global clusters and local clusters that are sub-clusters within the global clusters, the processor may output information such as summary information, main keywords, and core features for at least one of each of the global clusters or each of the local clusters.

According to the above-described embodiments, the user may select a cluster requiring a detailed review after preemptively reviewing the summary information for each cluster, and accordingly, the user’s document review efficiency may be improved. In addition, the user may determine at least one of a relevant keyword or an irrelevant keyword after preemptively reviewing the summary information for each cluster.

In operation 230, the processor may determine priorities of the retrieved documents based on at least one of degrees to which the retrieved documents contain the relevant keyword or degrees to which the retrieved documents contain the irrelevant keyword.

In an embodiment, the user device may obtain a relevant keyword or an irrelevant keyword according to at least one of a first method or a second method. Here, the “first method” may include a method of obtaining a relevant keyword or an irrelevant keyword based on a user input, and the “second method” may include a method of obtaining a relevant keyword or an irrelevant keyword from the above-described search criteria.

For example, the processor may obtain a relevant keyword or an irrelevant keyword from the search criteria according to the second method, and may obtain a relevant keyword or an irrelevant keyword by receiving a setting value regarding addition/deletion of a relevant keyword or an irrelevant keyword through a user interface unit included in the user device.

In an embodiment, the processor may calculate at least one of the degrees to which the retrieved documents contain the relevant keyword or the degrees to which the retrieved documents contain the irrelevant keyword.

In an embodiment, “a degree to which each of the retrieved documents contains relevant keywords” and “a degree to which each of the retrieved documents contains irrelevant keywords” may be calculated by the processor according to the ratio of the number of distinct relevant (or irrelevant) keywords contained in the corresponding document to the total number of relevant (or irrelevant) keywords.

In this case, determination of whether the corresponding document contains a relevant (or irrelevant) keyword may be performed by the processor by calculating similarity between words included in the corresponding document and the relevant (or irrelevant) keyword based on similarity scores between embedding vectors. Alternatively, in this case, determination of whether the corresponding document contains a relevant (or irrelevant) keyword may be performed by the processor by calculating similarity between a plurality of word combinations or sentences included in the document and the relevant (or irrelevant) keyword, based on similarity scores between embedding vectors.

For example, in a case where total relevant keywords are keywords A, B, C, and D, and a specific document contains keywords A and b, the degree to which the document contains the relevant keywords may be calculated as 50 %. In this case, it is assumed that keywords B and b are determined to be identical by the processor based on the similarity. In addition, in this case, each of the relevant keywords A, B, C, and D may refer to a single word, a plurality of words, or a sentence composed of a plurality of words and phrases, as described above.

In an embodiment, the processor may determine priorities of documents based on at least one of degrees to which the documents contain relevant keywords or degrees to which the documents contain irrelevant keywords. For example, the processor may determine a high priority for a document having a high degree of containing relevant keywords, and the processor may determine a low priority for a document having a high degree of containing irrelevant keywords.

In addition, in an embodiment, the priorities of the documents may be determined for respective clusters. For example, the processor may independently or in parallel perform an operation of determining priorities of a plurality of documents included in a first cluster and an operation of determining priorities of a plurality of documents included in a second cluster.

Although not illustrated in FIG. 2, in an embodiment, the processor may further perform an operation of setting at least one of a first threshold for a degree to which each of the retrieved documents contains relevant keywords or a second threshold for a degree to which each of the retrieved documents contains irrelevant keywords. In some embodiments, the processor may further perform an operation of excluding at least one of the retrieved documents from a list of retrieved documents displayed to the user, based on at least one of the degree to which each of the retrieved documents contains relevant keywords or the degree to which each of the retrieved documents contains irrelevant keywords, and the at least one threshold described above.

For example, the processor may set the first threshold for the degree of containing relevant keywords, according to a user input. In addition, the processor may set the second threshold for the degree of containing irrelevant keywords, according to a user input. In addition, the processor may perform at least one of an operation of excluding, from the list of retrieved documents displayed to the user, a document having a degree of containing relevant keywords less than the first threshold, or an operation of excluding, from the list of retrieved documents displayed to the user, a document having a degree of containing irrelevant keywords greater than the second threshold.

In an embodiment, setting values for the first threshold and the second threshold may be dynamically changed in response to a change in the user input. For example, in response to the setting value for the first threshold (or the second threshold) being changed by a user input, the processor may perform again the operation of comparing the degrees to which the retrieved documents contain relevant (or irrelevant) keywords with the first threshold (or the second threshold). In addition, the processor may update the list of retrieved documents displayed to the user.

Although not illustrated in FIG. 2, in an embodiment, the processor may further perform an operation of inputting query text received according to a user input and the retrieved documents into a large language model, and outputting response text generated for the query text to the user. Here, by using the large language model, the processor may generate response text for the query text based on at least one of text token information, context information, model training information, and information included in the input documents. That is, the generated response text may reflect the information included in the input documents.

In an embodiment, the retrieved documents input into the large language model may include documents included in any one of the above-described clusters. For example, in a case where the retrieved documents are clustered into first to third clusters, the processor may input all or some of the documents included in the first cluster into the large language model.

In another embodiment, the retrieved documents input into the large language model may include top n documents (where n is a natural number) having high priorities described above among the retrieved documents. For example, the processor may input, into the large language model, documents whose priorities determined in operation 230 are within the top 30 among the retrieved documents.

In another embodiment, the retrieved documents input into the large language model may be determined according to a user input. For example, the processor may input, into the large language model, at least one document selected according to a user input.

Although not illustrated in FIG. 2, in an embodiment, the processor may output at least one document related to at least one of the query text or the response text based on similarity between the at least one of the query text or the response text and the documents input to the large language model. In addition, the processor may sort a plurality of documents related to at least one of the query text or the response text in descending order of relevance, and output the sorted documents. Accordingly, the user may review in detail the documents related to the query text or the response text.

Although not illustrated in FIG. 2, in an embodiment, the processor may further perform an operation of inputting a predetermined prompt and the retrieved documents into the large language model, and outputting at least one of the documents input into the large language model based on the prompt.

Here, the “predetermined prompt” refers to a prompt input into the large language model. The prompt may be received according to a user input or generated based on a prompt generation algorithm, and may be determined based on domain knowledge and prompt engineering techniques.

For example, the prompt may be determined to include instructions according to a stepwise structure in which a problem-solving process (a document selecting process) is logically decomposed based on prompt techniques such as Chain of Thought, Least-to-Most, Plan and Solve, or Structured Chain of Thought. In detail, the prompt may be determined to include instructions according to a step-wise structure, such as: "1) focus on documents related to technology A1 in field A, 2) intensively review documents in which terms a1, a2, a3, a4, and a5 are mentioned within five words, 3) exclude documents including technologies that represent objectives or effects such as b1, b2, and b3, and 4) review and subdivide the results to comprehensively identify major developments in technology A1."

The processor may receive the prompt according to a user input and output at least one of the input documents by inputting the received prompt and the retrieved documents into the large language model.

FIG. 3 is a diagram exemplarily illustrating predetermined identification items extracted from retrieved documents, and content corresponding to the identification items, according to an embodiment.

(a) of FIG. 3 illustrates information or a table of contents included in a patent document. (b) of FIG. 3 illustrates structured data obtained by extracting predetermined identification items and content corresponding to the identification items.

As illustrated in (a) of FIG. 3, a patent document may include items such as a country code, an application number, a registration number, a title of invention, an abstract, and claims, and the user device may extract at least one of among these items as an identification item. Here, the identification item may be determined by the user based on a statistical/empirical analysis of a specific item or the like in which specific information that the user intends to obtain through a search is described, and the user device may receive, from the user, a setting value for the extracted identification item.

That is, in an embodiment, the processor may extract, from patent documents retrieved through a search, titles of invention 301, abstracts 302, and representative claims 303 as identification items. In addition, the processor may extract, from each of the patent documents, content 311 of a title of invention included in the patent document, content 312 of an abstract included in the patent document, and content 313 of a representative claim included in the patent document, as content corresponding to the respective identification items.

In addition, in an embodiment, the processor may generate a database by structuring metadata (e.g., a document identification code), the identification items, and the content corresponding to the identification items for each patent document.

For convenience of description, FIG. 3 illustrates specific examples of types of documents, identification items extracted from documents, and content corresponding to the identification items, but the present disclosure is not limited thereto. In other words, the types of documents, the identification items, and the content corresponding to the identification items may be modified by analogously applying the method of generating a database including retrieved documents according to the present disclosure.

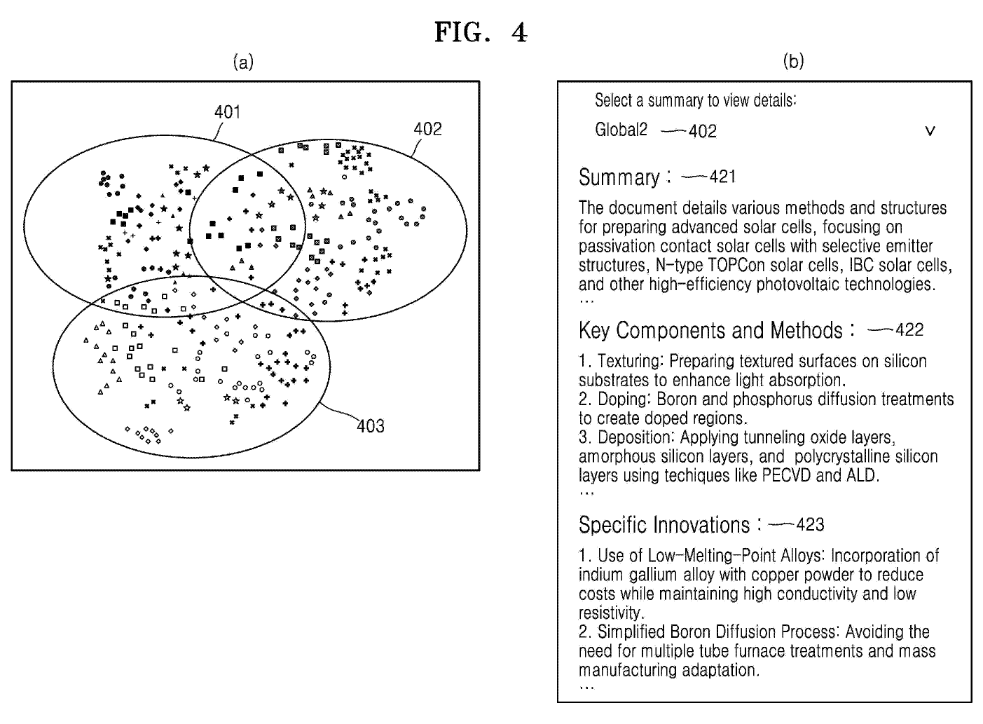

FIG. 4 is a diagram for describing clustering results and information displayed to a user in relation to the clustering results, according to an embodiment.

(a) of FIG. 4 is a graph that visualizes a distribution of a plurality of documents clustered according to the above-described method. (a) of FIG. 4 illustrates visualized boundary regions of a first cluster 401, a second cluster 402, and a third cluster 403.

Referring to (a) of FIG. 4, in an embodiment, the processor may cluster documents retrieved through a search into the first cluster 401, the second cluster 402, and the third cluster 403 based on similarity between the retrieved documents. In this case, documents having similar content may be included in each cluster. For example, the documents included in the first cluster 401 to the third cluster 403 may be documents commonly including first content to third content, respectively.

In addition, as illustrated in (a) of FIG. 4, regions in which the clusters overlap may exist. In other words, some of the retrieved documents may be included in one cluster and simultaneously included in at least one other cluster.

(b) of FIG. 4 is an exemplary diagram illustrating information output and displayed to a user for each of the clustered clusters according to the above-described method.

(b) of FIG. 4 illustrates summary information 421, key components and methods 422, and core features 423 that are output for the second cluster 402. Here, the summary information 421, the key components and methods 422, and the core features 423 may be generated based on content of documents included in the second cluster 402.

For convenience of description, (b) of FIG. 4 illustrates a specific example of information about clusters displayed to the user, but the present disclosure is not limited thereto. In other words, the information about the clusters displayed to the user may be modified by analogously applying the present disclosure.

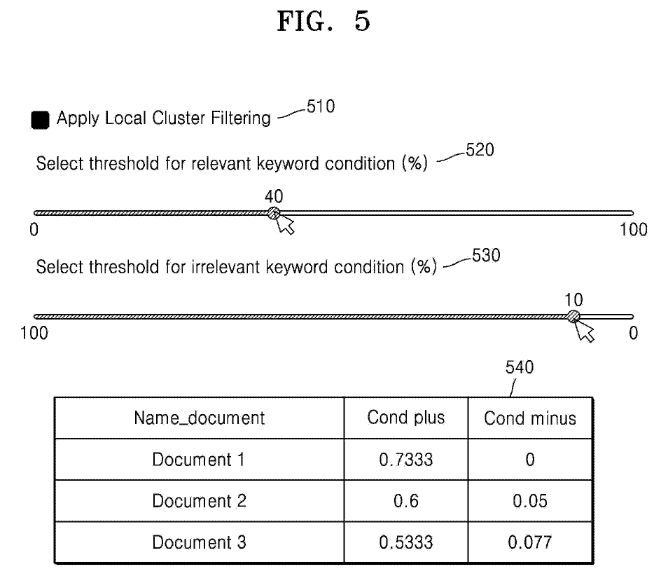

FIG. 5 is a diagram for describing information displayed to a user to receive a user input regarding a first threshold or a second threshold, according to an embodiment.

As described above, in an embodiment, the processor may further perform an operation of setting at least one of a first threshold for a degree to which each of the retrieved documents contains relevant keywords or a second threshold for a degree to which each of the retrieved documents contains irrelevant keywords. In some embodiments, the processor may further perform an operation of excluding at least one of the retrieved documents from a list of retrieved documents displayed to the user, based on at least one of the degree to which each of the retrieved documents contains relevant keywords or the degree to which each of the retrieved documents contains irrelevant keywords, and the at least one threshold described above.

Referring to FIG. 5, the user device may display, to the user, a first threshold setting interface 520 for receiving a user input regarding the first threshold, and a second threshold setting interface 530 for receiving a user input regarding the second threshold.

In an embodiment, the user device may display, to the user, documents whose degrees of containing relevant keywords are greater than or equal to the first threshold that is received according to a user input, among the retrieved documents. Conversely, the user device may exclude, from a document list 540 displayed to the user, documents whose degrees of containing relevant keywords are less than the first threshold that is received according to the user input.

In an embodiment, the user device may display, to the user, documents whose degrees of containing irrelevant keywords are less than or equal to the second threshold received according to a user input, among the retrieved documents. Conversely, the user device may exclude, from the document list 540 displayed to the user, documents whose degrees of containing irrelevant keywords are greater than the second threshold that is received according to the user input.

In an embodiment, setting values for the first threshold and the second threshold may be dynamically changed in response to a change in the user input.

For example, in response to a new setting value for the first threshold being input by the user through the first threshold setting interface 520, the user device may perform again the operation of comparing the degree to which each of the retrieved documents contains relevant keywords with the first threshold. In addition, the user device may update the document list 540 to display, to the user, documents whose degrees of containing relevant keywords are greater than or equal to the newly input first threshold, among the retrieved documents.

Conversely, in response to receiving a new input regarding the second threshold from the user through the second threshold setting interface 530, the user device may perform again the operation of comparing the degree to which each of the retrieved documents contains irrelevant keywords with the second threshold. In addition, the user device may update the document list 540 to display, to the user, documents whose degrees of containing irrelevant keywords are less than or equal to the newly input second threshold, among the retrieved documents.

Referring again to FIG. 5, a case is illustrated where a user input received by the user device through the first threshold setting interface 520 is 40 % and a user input received through the second threshold setting interface 530 is 10 %. In this case, the user device may display, in the document list 540, three documents whose degrees of containing relevant keywords are 40 % or greater and whose degrees of containing irrelevant keywords are 10 % or less. In addition, in this case, the user device may sort a plurality of documents displayed in the document list 540 in ascending order or descending order based on at least one of the degree of containing relevant keywords or the degree of containing irrelevant keywords.

In an embodiment, the user device may display, to the user, an activation interface 510 for receiving a user input regarding whether to perform an operation for excluding at least one of the retrieved documents from the document list 540 based on the first threshold or the second threshold. In this case, only when an operation activation input is received from the user, the user device may perform the operation for excluding at least one of the retrieved documents from the document list 540 based on the first threshold or the second threshold.

Although FIG. 5 illustrates a case of performing the operation of excluding at least one of the retrieved documents from the document list 540 based on the degree of containing relevant keywords or the degree of containing irrelevant keywords for each document, the present disclosure is not limited thereto.

That is, in an embodiment, the user device may perform an operation of excluding at least one cluster from a cluster list displayed to the user among all clusters based on the degrees of containing relevant keywords or the degrees of containing irrelevant keywords for each cluster. Here, the degree of containing relevant (or irrelevant) keywords for each cluster may be calculated by the processor of the user device based on the ratio of the number of distinct relevant (or irrelevant) keywords contained in documents included in each cluster to the total number of relevant (or irrelevant) keywords.

In this case, as a criterion for determining whether each of the clusters contains relevant (or irrelevant) keywords, a certain criterion regarding "the ratio of documents containing the relevant (or irrelevant) keywords among documents included in the cluster" may be provided. For example, when even any one document among the documents included in the cluster contains the corresponding relevant (or irrelevant) keyword, the corresponding cluster may be determined by the processor as containing the relevant keyword. As another example, when the ratio of documents containing the corresponding relevant (or irrelevant) keyword among the documents included in the cluster is a % or greater, the cluster may be determined by the processor as containing the relevant (or irrelevant) keyword.

In addition, in this case, each relevant (or irrelevant) keyword may refer to a single word, a plurality of words, or a sentence composed of a plurality of words and phrases, as described above.

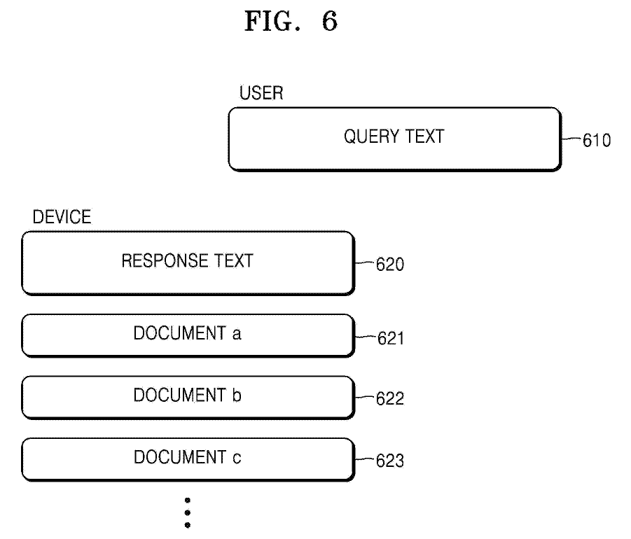

FIG. 6 is a diagram for describing a process of outputting response text for query text received according to a user input, according to an embodiment.

FIG. 6 illustrates response text 620 output by the user device for query text 610 received according to a user input. In addition, FIG. 6 illustrates that a document a 621, a document b 622, and a document c 623 that are related to at least one of the query text 610 or the response text 620 are output by the user device.

In an embodiment, the processor may perform an operation of inputting the query text 610 and the retrieved documents into a large language model, and outputting the response text 620 generated for the query text 610 to the user. Here, by using the large language model, the processor may generate the response text 620 for the query text 610 based on at least one of text token information, context information, model training information, and information included in the input documents. That is, the response text 620 illustrated in FIG. 6 may include text output by the large language model reflecting information included in the input documents.

In addition, in an embodiment, the user device may output, along with the response text 620, the document a 621, the document b 622, and the document c 623 that are related to at least one of the query text 610 or the response text 620. Here, the document a 621, the document b 622, and the document c 623 may include documents that are selected from among the retrieved documents input into the large language model based on relevance to at least one of the query text 610 or the response text 620.

In this case, the user device may calculate the relevance based on similarity between the documents input into the large language model and at least one of the query text 610 or the response text 620. For example, the user device may calculate the relevance based on similarity scores between embedding vectors corresponding to the documents input into the large language model and an embedding vector corresponding to the query text 610. Similarly, the user device may calculate the relevance based on similarity scores between the embedding vectors corresponding to the documents input into the large language model and an embedding vector corresponding to the response text 620.

In an embodiment, the user device may output, along with the response text 620, m documents (where m is a natural number) having high relevance to at least one of the query text 610 or the response text 620 among the documents input into the large language model. For example, as illustrated in FIG. 6, the user device may output, along with the response text 620, the document a 621, the document b 622, and the document c 623, which are three documents having high relevance to at least one of the query text 610 or the response text 620.

In addition, the user device may sort the document a 621, the document b 622, and the document c 623 that are output along with the response text 620, in descending order of relevance, and output the sorted documents. That is, as illustrated in FIG. 6, the document a 621, the document b 622, and the document c 623 may include documents sorted and output in descending order of relevance.

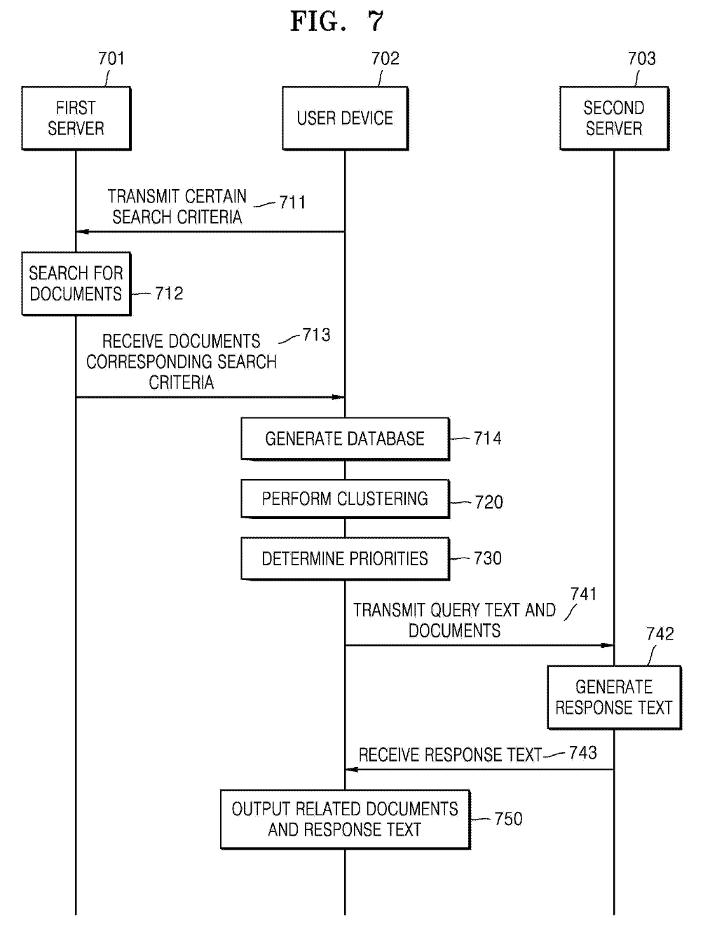

FIG. 7 is a flowchart for describing a method, performed by a user device, of processing a plurality of documents through a first server and a second server, according to an embodiment.

A first server 701, a user device 702, and a second server 703 of FIG. 7 may correspond to the first server 20, the user device 10, and the second server 30 of FIG. 1, respectively.

In operations 711 to 714, the user device 702 may transmit, to the first server 701, predetermined search criteria received according to a user input. In addition, based on the search criteria, the first server 701 may perform a search for documents corresponding to the search criteria. In addition, the user device 702 may receive, from the first server 701, documents retrieved through the search, and generate a database including the retrieved documents. Here, a specific example in which the user device 702 operates to generate the database is as described above.

In operation 720, the user device 702 may cluster the retrieved documents into a plurality of clusters based on similarity between the documents included in the database. Here, a specific example in which the user device 702 operates to cluster the retrieved documents into the plurality of clusters is as described above.

In operation 730, the user device 702 may determine priorities of the retrieved documents based on at least one of degrees to which the retrieved documents contain relevant keywords or degrees to which the retrieved documents contain irrelevant keywords. Here, a specific example in which the user device 702 operates to determine the priorities of the retrieved documents is as described above.

In operations 741 to 743, the user device 702 may transmit, to the second server 703, query text received according to a user input and the retrieved documents. In addition, the second server 703 may generate response text based on the retrieved documents by using a large language model. In addition, the user device 702 may receive the generated response text from the second server 703.

In operation 750, the user device 702 may output, along with the response text, documents related to at least one of the query text or the response text among the documents input into the large language model. Here, a specific example in which the user device 702 operates to output the documents related to at least one of the query text or the response text along with the response text is as described above.

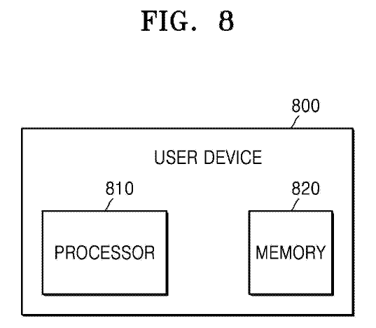

FIG. 8 is a block diagram of a user device according to an embodiment.

Referring to FIG. 8, a user device 800 may include a processor 810 and a memory 820. FIG. 8 illustrates the user device 800 including only the components associated with an embodiment. Thus, it would be understood by those of skill in the art that other general-purpose components may be further included in addition to those illustrated in FIG. 8. For example, although not illustrated in FIG. 8, the user device 800 may further include a communication unit configured to enable communication with an external server or an external device, an interface unit configured to enable interaction with a user, and the like.

The processor 810 controls the overall operation of the user device 800. For example, by executing programs stored in the memory 820, the processor 810 may control the overall operation of components included in the user device 800. In addition, by executing programs stored in the memory 820, the processor 810 may control the operation of the user device 800.

The processor 810 may control at least some of the operations of the user device 800 described above with reference to FIGS. 1 to 7. For example, the processor 810 may control at least some of operations of generating a database including documents retrieved according to predetermined search criteria, clustering the retrieved documents into a plurality of clusters based on similarity between the documents included in the database, and determining priorities of the retrieved documents based on at least one of degrees to which the retrieved documents contain relevant keywords or degrees to which the retrieved documents contain irrelevant keywords.

A detailed example of an operation of the processor 810 is as described above with reference to FIGS. 1 to 7. Thus, detailed descriptions of the operation of the processor 810 will be omitted.

The processor 810 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the user device 800 may be a mobile electronic device. For example, the user device 800 may be implemented as a smart phone, a tablet PC, a PC, a smart television (TV), a personal digital assistant (PDA), a laptop computer, a media player, a navigation system, a camera-equipped device, and other mobile electronic devices. In some embodiments, the user device 800 may be implemented as a wearable device having a communication function and a data processing function, such as a watch, glasses, a hair band, or a ring.

In another embodiment, the user device 800 may be a server. The server may be implemented as a computer device or a plurality of computer devices that provide a command, code, a file, content, a service, and the like by performing communication through a network.

An embodiment of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a compact disc read-only memory (CD-ROM) or a digital video disc (DVD), a magneto-optical medium, such as a floptical disk, and a hardware device specially configured to store and execute program instructions, such as read-only memory (ROM), random-access memory (RAM), or flash memory.

In addition, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to the above-described embodiments of the present disclosure, the efficiency of a user’s document review may be improved by clustering retrieved documents based on similarity between the documents and providing the user with information useful for review, such as summary information for each cluster.

Furthermore, the efficiency of the user’s document review may be improved by obtaining relevant keywords or irrelevant keywords determined by the user through a primary review of output search result information, and providing the user with priorities for a secondary review obtained based on the relevant keywords or the irrelevant keyword. Furthermore, the volume of documents to be reviewed by the user may be reduced through a document selecting process that excludes, from the retrieved documents, documents that do not contain information desired by the user.

In addition, the efficiency of the user’s document review may be enhanced by generating and providing a response based on information about the retrieved documents in response to the user’s query regarding the content of the retrieved documents, and by obtaining and providing documents related to the user’s query and the response.

According to an embodiment, the method according to various embodiments of the present disclosure may be included in a computer program product and provided. The computer program product may be traded as a commodity between sellers and buyers. The computer program product may be distributed in the form of a machine-readable storage medium (e.g., a CD-ROM), or may be distributed online (e.g., downloaded or uploaded) through an application store (e.g., Play StoreTM) or directly between two user devices. In a case of online distribution, at least a portion of the computer program product may be temporarily stored in a machine-readable storage medium such as a manufacturer’s server, an application store’s server, or a memory of a relay server.

The operations of the methods according to the present disclosure may be performed in any suitable order unless otherwise indicated herein or otherwise clearly contradicted by context. The present disclosure is not limited to the described order of the operations. The use of any and all examples, or exemplary language provided herein, is intended merely to better illuminate the present disclosure and does not pose a limitation on the scope of the present disclosure unless otherwise claimed. Also, numerous modifications and adaptations will be readily apparent to those skilled in the art without departing from the spirit and scope of the present disclosure.

Accordingly, the spirit of the present disclosure should not be limited to the above-described embodiments, and all modifications and variations which may be derived from the meanings, scopes and equivalents of the claims should be construed as falling within the scope of the present disclosure.

What is claimed is:

1. A method of processing a plurality of documents, the method comprising:
generating a database including documents that are retrieved according to predetermined search criteria;
clustering the retrieved documents into a plurality of clusters based on similarity between documents included in the database; and
determining priorities of the retrieved documents based on at least one of degrees to which the retrieved documents contain a relevant keyword or degrees to which the retrieved documents contain an irrelevant keyword.

2. The method of claim 1, wherein the generating comprises:
receiving documents corresponding to the search criteria; and
extracting, from the retrieved documents, a predetermined identification item and content corresponding to the identification item.

3. The method of claim 1, wherein the clustering comprises:
obtaining, for each of the retrieved documents, an embedding vector corresponding to text included in the retrieved document; and
clustering the retrieved documents into the plurality of clusters based on similarity scores between the embedding vectors.

4. The method of claim 1, further comprising outputting information including at least one of summary information for each of the plurality of clusters, main keywords for each of the plurality of clusters, or core features for each of the plurality of clusters.

5. The method of claim 1, wherein the clustering comprises:
clustering the retrieved documents into global clusters based on the similarity between the retrieved documents; and
clustering documents included in each of the global clusters into local clusters based on the similarity between the retrieved documents included in the global clusters.

6. The method of claim 1, wherein the determining comprises:
calculating a degree to which the retrieved documents included in each of the plurality of clusters contain the relevant keyword and a degree to which the retrieved documents included in each of the plurality of clusters contain the irrelevant keyword; and
determining, for each of the plurality of clusters, the priorities of the retrieved documents based on at least one of the calculated degree to which the retrieved documents contain the relevant keyword or the calculated degree to which the retrieved documents contain the irrelevant keyword.

7. The method of claim 6, wherein the relevant keyword or the irrelevant keyword is obtained according to at least one of a first method of obtaining the relevant keyword or the irrelevant keyword based on a user input, or a second method of obtaining the relevant keyword or the irrelevant keyword from the search criteria.

8. The method of claim 1, further comprising:
setting at least one threshold among a first threshold for the degrees to which the retrieved documents contain the relevant keyword or a second threshold for the degrees to which the retrieved documents contain the irrelevant keyword; and
excluding, from a list of documents displayed to the user, at least one of the retrieved documents based on at least one of the degree to which each of the retrieved documents contains the relevant keyword or the degree to which each of the retrieved documents contains the irrelevant keyword, and the at least one threshold.

9. The method of claim 1, further comprising outputting response text for query text that is received according to a user input, by inputting the query text, and the retrieved documents into a large language model.

10. The method of claim 9, further comprising outputting at least one document related to at least one of the query text or the response text, based on similarity between the at least one of the query text or the response text and the retrieved documents input into the large language model.

11. The method of claim 9, wherein the retrieved documents input into the large language model include documents included in any one of the plurality of clusters.

12. The method of claim 1, further comprising:
inputting, into a large language model, a predetermined prompt and the retrieved documents; and
outputting at least one of the retrieved documents input into the large language model based on the prompt.

13. A computer-readable recording medium having recorded thereon a program for causing a computer to execute the method of claim 1.

14. A device for processing a plurality of documents, the device comprising:
a memory storing at least one program; and
a processor configured to operate by executing the at least one program,
wherein the processor is further configured to generate a database including documents that are retrieved according to predetermined search criteria, cluster the retrieved documents into a plurality of clusters based on similarity between documents included in the database, and determine priorities of the retrieved documents based on at least one of degrees to which the retrieved documents contain a relevant keyword or degrees to which the retrieved documents contain an irrelevant keyword.

15. The device of claim 14, further comprising a user interface unit,
wherein the processor is further configured to output information including at least one of summary information for each of the plurality of clusters, main keywords for each of the plurality of clusters, or core features for each of the plurality of clusters through the user interface unit.

16. The device of claim 14, wherein the processor is further configured to set at least one threshold among a first threshold for the degrees to which the retrieved documents contain the relevant keyword or a second threshold for the degrees to which the retrieved documents contain the irrelevant keyword, and exclude, from the retrieved documents, at least one of the retrieved documents based on information including at least one of the degree to which each of the retrieved documents contains the relevant keyword or the degree to which each of the retrieved documents contains the irrelevant keyword, and the at least one threshold.

17. The device of claim 14, wherein the processor is further configured to generate response text for query text that is received according to a user input, by inputting the query text, and the retrieved documents into a large language model.

18. The device of claim 17, wherein the processor is further configured to output at least one document related to at least one of the query text or the response text, based on similarity between the at least one of the query text or the response text and the retrieved documents.

19. The device of claim 14, wherein the processor is further configured to input, into a large language model, a predetermined prompt and the retrieved documents, and output at least one of the retrieved documents input into the large language model based on the prompt.

20. The device of claim 14, wherein the processor is further configured to input a predetermined prompt and the retrieved documents into a large language model, to output documents selected based on the prompt.
